(19) United States
(12) Patent Application Publication
(10) Pub. No.: US 2026/0296194 A1
(43) Pub. Date: Oct. 1, 2026

(54) STREAMING SYSTEM, STORAGE MEDIUM, AND STREAMING METHOD

(71) Applicant: HONDA MOTOR CO., LTD., Tokyo (JP)

(72) Inventor: Junichiro Onaka, Tokyo (JP)

(21) Appl. No.: 19/548,341

(22) Filed: Feb. 24, 2026

(30) Foreign Application Priority Data
Mar. 28, 2025 (JP) 2025-056382

(51) Int. Cl. B60K 35/28

(52) U.S. Cl. CPC B60K 35/28

(57) ABSTRACT

A streaming system including: a vehicle in which a capturing apparatus is provided and that streams an image obtained through capturing by the capturing apparatus; and a terminal apparatus that receives, from the vehicle, invite information for inviting viewing of the streamed image, wherein when the invite information is transferred from the terminal apparatus to another terminal apparatus, the vehicle notifies an occupant of the vehicle that the invite information has been transferred.

### INCORPORATION BY REFERENCE

The present application claims priority under 35 U.S.C. § 119 to Japanese Patent Application No. 2025-056382 filed on Mar. 28, 2025. The content of the application is incorporated herein by reference in its entirety.

### BACKGROUND OF THE INVENTION

### Field of the Invention

The present invention relates to a streaming system, a storage medium and a streaming method.

### Description of the Related Art

In recent years, efforts have been accelerating to provide access to sustainable transportation systems that take into account vulnerable traffic participants such as the elderly, people with disabilities, and children. To this end, efforts are focused on research and development for further improving the safety and convenience of traffic through the development of means of transportation for vulnerable road users. There is a method of viewing a moving image streamed by a streamer of an image (for example, see Japanese Patent Laid-Open No. 2024-039763), without a person in a vulnerable position personally having to enter a mobile body to access a transportation system. Japanese Patent Laid-Open No. 2024-039763 discloses transmitting an image captured by a camera unit provided in a vehicle to an apparatus used at a different location than the vehicle. Japanese Patent Laid-Open No. 2024-039763 discloses a mobile body that transmits a matching request from an occupant upon accepting an input of the matching request.

Invite information for inviting viewing of the image, such as the matching request, may be transferred between different terminal apparatuses. For example, in a situation in which a terminal apparatus of a care recipient has received the invite information, it is assumed that the terminal apparatus of the care recipient transfers the invite information to a terminal apparatus of a caregiver, when the care recipient and the caregiver view the image. In the related art, however, someone who has not been invited via the invite information can become a viewer not intended by the occupant of the vehicle, since the occupant of the vehicle is not capable of knowing to whom the invite information is transferred.

The present invention was made in view of the above-described circumstances and has an object to enable an occupant of a vehicle to know that someone who has not been invited via the invite information can become a viewer. Therefore, through a service for connecting remote locations and vehicles, the present invention contributes to supporting good connection between urban areas and regional areas such as those surrounding urban areas, and to the development of sustainable transportation systems.

### SUMMARY OF THE INVENTION

An aspect of the present invention is a streaming system including: a vehicle in which a capturing apparatus is provided and configured to stream an image obtained through capturing by the capturing apparatus; and a terminal apparatus provided in a location other than the vehicle and configured to receive, from the vehicle, invite information for inviting viewing of the streamed image, wherein when the invite information is transferred from the terminal apparatus to another terminal apparatus, the vehicle notifies an occupant of the vehicle that the invite information has been transferred.

According to the above aspect of the present invention, an occupant of a vehicle is capable of knowing that someone who has not been invited via invite information can become a viewer.

### BRIEF DESCRIPTION OF THE DRAWINGS

FIG. 1 is a diagram showing a system configuration of a streaming system;

FIG. 2 is a diagram showing an attachment example of a streamer terminal in a vehicle;

FIG. 3 is a diagram showing the attachment example of the streamer terminal in the vehicle;

FIG. 4 is a diagram showing a configuration of the vehicle and a streaming server;

FIG. 5 is a diagram showing functional units of a first processor;

FIG. 6 is a diagram showing an example of first invite information;

FIG. 7 is a diagram showing an example of second invite information;

FIG. 8 is a diagram showing a configuration of a user information DB;

FIG. 9 is a diagram showing a configuration of a stream management DB;

FIG. 10 is a diagram showing functional units of a second processor;

FIG. 11 is a block diagram showing a configuration of a viewer terminal;

FIG. 12 is a sequence diagram showing an operation of an in-vehicle apparatus, the streaming server, the viewer terminal, and another viewer terminal;

FIG. 13 is a sequence diagram showing an operation of the viewer terminal, the streaming server, and the in-vehicle apparatus;

FIG. 14 is a sequence diagram showing an operation of the viewer terminal, the streaming server, and the in-vehicle apparatus; and

FIG. 15 shows flowcharts showing an operation of the in-vehicle apparatus, the streaming server, and the viewer terminal.

### DETAILED DESCRIPTION OF THE INVENTION

### 1. Configuration of Streaming System

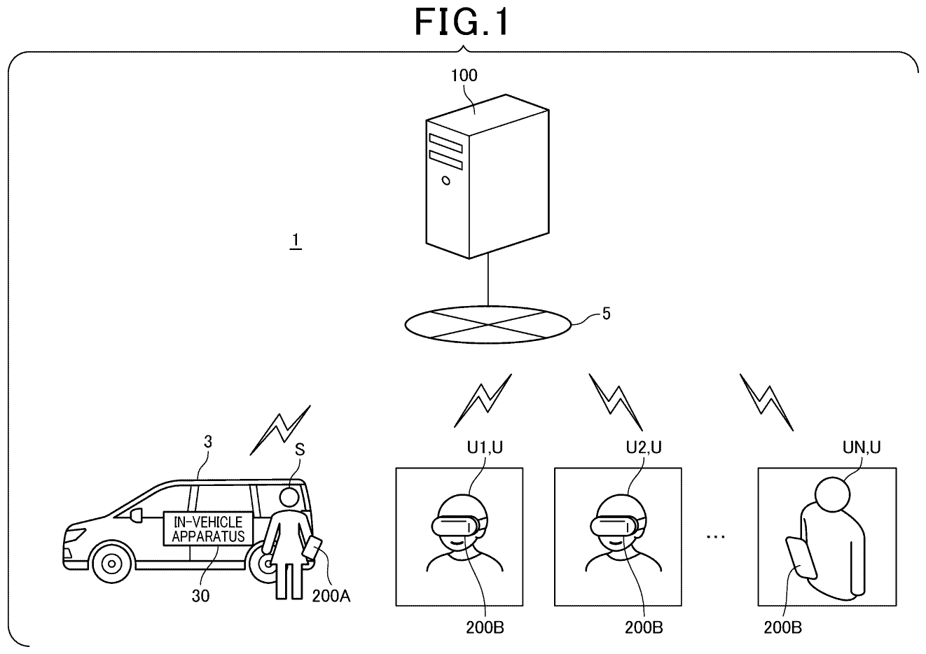

FIG. 1 is a diagram showing a system configuration of a streaming system 1.

The streaming system 1 includes a vehicle 3, a streamer terminal 200A, a streaming server 100, and a viewer terminal 200B. The streaming system 1 is a system for live streaming content including an image obtained through capturing by the streamer terminal 200A.

Live streaming refers to streaming the image obtained through capturing by the streamer terminal 200A to the viewer terminal 200B in real-time. The image may be a still image or a moving image.

The streamer terminal 200A is an example of a “capturing apparatus.” The viewer terminal 200B is an example of a “terminal apparatus.”

An in-vehicle apparatus 30 is installed in the vehicle 3. The in-vehicle apparatus 30 is wirelessly connected via short-range wireless communication or the like to the streamer terminal 200A possessed by a streamer S being an occupant of the vehicle 3. The in-vehicle apparatus 30 receives, from the streamer terminal 200A, the image obtained through capturing by a camera included in the streamer terminal 200A.

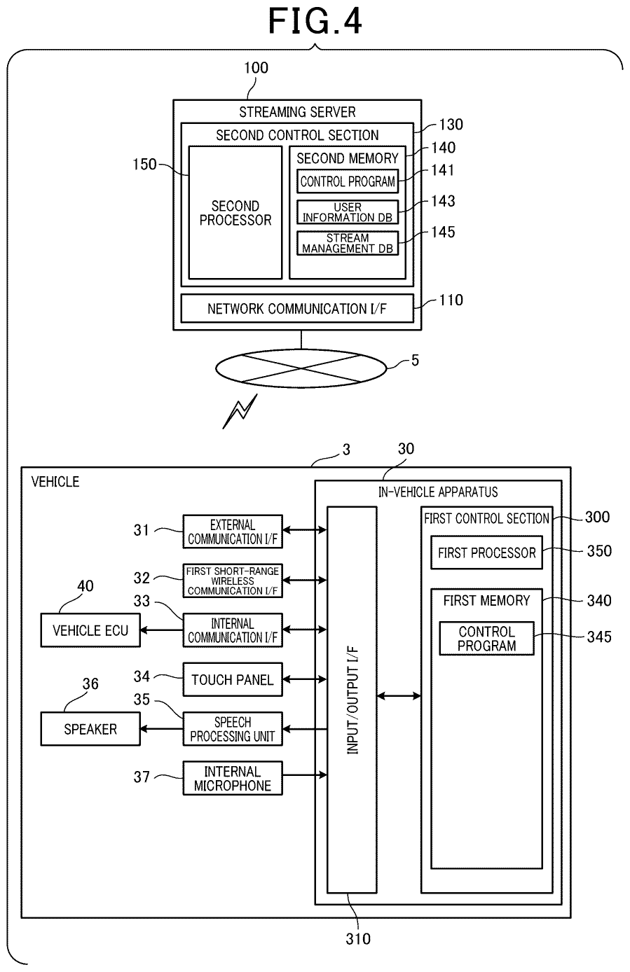

The in-vehicle apparatus 30 receives, from an internal microphone 37 (see FIG. 4), sound collected by the internal microphone 37. Note that the internal microphone 37 is a microphone provided in the vehicle 3.

The in-vehicle apparatus 30 uploads content data including the received image, sound, and the like to the streaming server 100.

The streamer terminal 200A may be a smartphone or tablet personal computer (PC), or may be a camera such as a digital camera or a 360-degree camera capable of capturing an entire surrounding area. Note that when the streamer terminal 200A is a smartphone or tablet PC, the internal microphone 37 may be the streamer terminal 200A.

The streamer terminal 200a is provided in the vehicle 3.

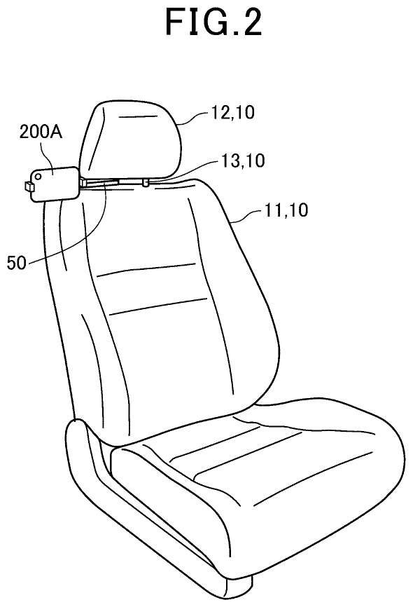

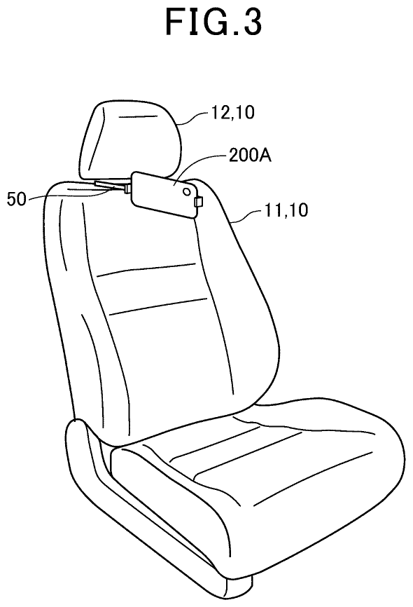

FIGS. 2 and 3 are diagrams showing attachment examples of the streamer terminal 200A in the vehicle 3.

FIGS. 2 and 3 show examples in which the streamer terminal 200A is attached to a passenger seat 10 of the vehicle 3.

The streamer terminal 200A is attached to the seat 10 via an attachment 50. The attachment 50 is attached to a headrest stay 13 that fixes a headrest 12 of the passenger seat 10 to a backrest 11.

FIG. 2 shows an example in which the streamer terminal 200A is attached to the passenger seat 10 so that an area in front of the vehicle 3 is included in an angle of view of the streamer terminal 200A. This attachment position of the streamer terminal 200A is referred to as a first position. FIG. 3 shows an example in which the streamer terminal 200A is attached to the passenger seat 10 so that the streamer S seated in a driver seat is included in the angle of view of the streamer terminal 200A. This attachment position of the streamer terminal 200A is referred to as a second position.

A first holder 51 for fixing the streamer terminal 200A to the attachment 50 is provided at one end portion of the attachment 50 and a second holder for fixing the attachment 50 to the headrest stay 13 is provided at the other end portion of the attachment 50. Illustration of the second holder is omitted. After changing an attachment direction of the attachment 50 to the headrest stay 13, the streamer terminal 200A is attached to the passenger seat 10 in the first position or the second position by fixing the attachment 50 to the headrest stay 13 via the second holder.

Returning to the description of FIG. 1, the streaming server 100 streams content streamed from the vehicle 3 to the viewer terminal 200B of a viewer U. This streaming technology can be realized using known technology such as HTTP Live Streaming (HLS), Common Media Application Format (CMAF), Web Real-Time Communication (WebRTC), or Real-Time Messaging Protocol (RTMP).

The viewer terminal 200B is a terminal apparatus possessed by the viewer U that views the content streamed from the streaming server 100. In other words, the viewer U is a user of the viewer terminal 200B. FIG. 1 shows U1, U2, . . . , UN viewers U as the viewer U. N is an arbitrary natural number. The viewer terminal 200B is provided in a location other than the vehicle 3.

For example, the viewer terminal 200B may be a portable or mobile terminal apparatus such as a smartphone, a tablet PC, or a notebook PC, or may be a stationary terminal apparatus such as a desktop PC. The viewer terminal 200B may be a television set, or a head-mounted display apparatus in which an image display part is mounted on the head of the viewer U and a display included in the image display part is arranged in front of the eyes of the viewer U. The head-mounted display apparatus may be transmissive or non-transmissive, as long as the content streamed from the streaming server 100 can be viewed.

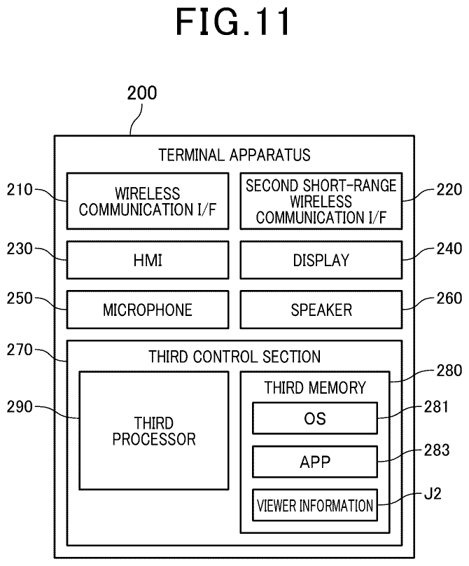

The viewer terminal 200B includes a display 240 (see FIG. 11) and a speaker 260 (see FIG. 11), displays an image streamed from the streaming server 100 on the display 240, and outputs speech streamed from the streaming server 100 via the speaker 260.

The viewer terminal 200B includes a microphone 250 (see FIG. 11) and uploads speech data of the viewer U collected by the microphone 250 to the streaming server 100. The streaming server 100 transmits the uploaded speech data of the viewer U to the in-vehicle apparatus 30. The in-vehicle apparatus 30 then outputs the speech indicated by the received speech data of the viewer U in the vehicle 3 via a speaker 36 (see FIG. 4). With this, the viewer U and the streamer S can converse during streaming of the content.

A communication network 5 is a wired or wireless transmission path for information transmitted from an apparatus connected to the communication network 5. For example, the communication network 5 may include a public network such as the Internet, a mobile communication network, a satellite communication network, or various local area networks (LANs) including Ethernet (registered trademark) or a wide area network (WAN). The communication network 5 may include a dedicated network such as an Internet protocol-virtual private network (IP-VPN).

### 2. Configuration of Vehicle

FIG. 4 is a diagram showing a configuration of the vehicle 3 and the streaming server 100.

First, the configuration of the vehicle 3 will be described with reference to FIG. 4.

The vehicle 3 includes the in-vehicle apparatus 30, an external communication interface 31, a first short-range wireless communication interface 32, an internal communication interface 33, a touch panel 34, a speech processing unit 35, the speaker 36, and the internal microphone 37. Hereinafter, interface will be abbreviated as I/F.

First, the external communication interface 31, the first short-range wireless communication interface 32, the internal communication interface 33, the touch panel 34, the speech processing unit 35, the speaker 36, and the internal microphone 37 will be described.

The external communication I/F 31 is a communication module that performs wireless communication in accordance with a mobile communication standard such as long-term evolution (LTE), fourth-generation (4G), 5G, or Wi-Fi (registered trademark). The external communication I/F 31 is connected to the communication network 5 via an antenna (not shown) and performs mutual data transmission/reception with the streaming server 100. Note that the external communication I/F 31 is, for example, a telematics control unit (TCU).

For example, the first short-range wireless communication I/F 32 (transmitter/receiver, circuit) is a communication apparatus that performs wireless communication in accordance with a short-range wireless communication standard such as Bluetooth (registered trademark) or Wi-Fi. For example, the first short-range wireless communication I/F 32 is a communication module that performs communication in accordance with a near-field communication (NFC) standard such as Bluetooth or Wi-Fi. The first short-range wireless communication I/F 32 performs short-range wireless communication with a terminal apparatus possessed by an occupant and receives an image, speech, and the like captured by the terminal apparatus.

The internal communication I/F 33 (transmitter/receiver, circuit) is an input/output interface connected to an in-vehicle network (not shown). For example, a communication bus supporting a communication standard such as controller area network (CAN), CAN with Flexible Data-Rate (CAN FD), or Ethernet is used for the in-vehicle network. The internal communication I/F 33 performs mutual data communication via the in-vehicle network with in-vehicle equipment such as a vehicle ECU 40 (computer) or another relay apparatus.

The touch panel 34 includes a display panel such as a liquid-crystal panel or an organic electroluminescent (EL) panel, and a touch sensor. The touch sensor detects a touch operation by the viewer U on the touch panel 34 and outputs position information indicating a position of the detected touch operation to a first control section 330.

For example, the speech processing unit 35 (processor) converts digital speech data output by the first control section 330 into an analog speech signal. The speech processing unit 35 amplifies the converted analog speech signal and outputs the amplified speech signal via the speaker 36.

The internal microphone 37 is provided at a predetermined position inside the vehicle 3, and collects internal environmental sound of the vehicle 3. When the streamer S speaks inside the vehicle 3, the internal environmental sound includes the speech of the streamer S. The internal microphone 37 outputs data of the collected internal environmental sound to the in-vehicle apparatus 30.

The in-vehicle apparatus 30 includes an input/output I/F 310 and the first control section 330.

The input/output I/F 310 functions as a connection unit between the first control section 330 and the external communication I/F 31, the first short-range wireless communication I/F 32, the internal communication I/F 33, the touch panel 34, the speech processing unit 35, and the internal microphone 37. The input/output I/F 310 includes a connector and an interface circuit. The input/output I/F 310 outputs data input from the external communication I/F 31, the first short-range wireless communication I/F 32, the internal communication I/F 33, the touch panel 34, the speech processing unit 35, and the internal microphone 37 to the first control section 330. The input/output I/F 310 outputs data input from the first control section 330 to the external communication I/F 31, the first short-range wireless communication I/F 32, the internal communication I/F 33, the touch panel 34, and the speech processing unit 35.

The first control section 330 is a computer apparatus including a first memory 340 and a first processor 350.

The first processor 350 is an example of a “processor.”

The first memory 340 includes, for example, a volatile semiconductor memory and a non-volatile semiconductor memory. The first memory 340 may include only a non-volatile semiconductor memory. The first memory 340 may include an auxiliary storage apparatus such as a solid-state drive (SSD). The first memory 340 stores a control program 345 executed by the first processor 350, configuration data that defines an operation of the in-vehicle apparatus 30, and the like.

The control program 345 is an example of a “program.”

The first processor 350 is, for example, an arithmetic processing apparatus such as a central processing unit (CPU) or a microprocessing unit (MPU). The first processor 350 may be implemented as a single processor or as a plurality of processors. The first processor 350 may be implemented as a system on a chip (SoC) integrated with part or all of the first memory 340, or with another circuit.

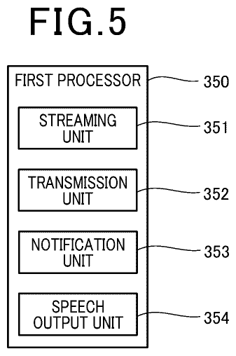

FIG. 5 is a diagram showing functional units of the first processor 350.

The first processor 350 functions as a streaming unit 351, a transmission unit 352, a notification unit 353, and a speech output unit 354 by loading and executing the control program 345 stored in the first memory 340.

### 2-1. Streaming Unit

The streaming unit 351 acquires the image from the streamer terminal 200A via the first short-range wireless communication I/F 32 and streams the acquired image to the viewer terminal 200B. More specifically, the streaming unit 351 uploads, to the streaming server 100 via the external communication I/F 31, content data including the image acquired from the streamer terminal 200A along with a stream identification (ID) J1 for identifying a stream. When the internal microphone 37 collects the internal environmental sound of the vehicle 3, the streaming unit 351 uploads content data further including the internal environmental sound to the streaming server 100.

### 2-2. Transmission Unit

The transmission unit 352 transmits invite information SJ via the external communication I/F 31. The invite information SJ is information for inviting viewing of the streamed image. The transmission unit 352 transmits at least any of first invite information SJ1 or second invite information SJ2.

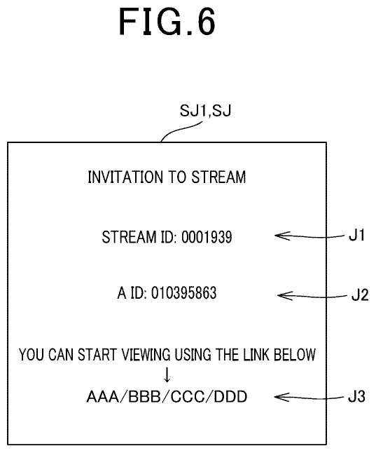

FIG. 6 is a diagram showing an example of the first invite information SJ1.

The first invite information SJ1 is the invite information SJ transmitted to the viewer terminal 200B of the viewer U designated by the streamer S. The first invite information SJ1 is the invite information SJ whose transferable count is set to one time.

The first invite information SJ1 includes the stream ID J1, viewer information J2, and access information J3.

The viewer information J2 is information of the viewer U, and includes a name of the viewer U and a user ID of the viewer U. The viewer information J2 included in the first invite information SJ1 is the viewer information J2 of the viewer U designated by the streamer S. Note that the user ID is identification information for identifying a user utilizing a streaming service provided by the streaming server 100.

The access information J3 is information for starting viewing of the streamed image, and a link is given as an example thereof.

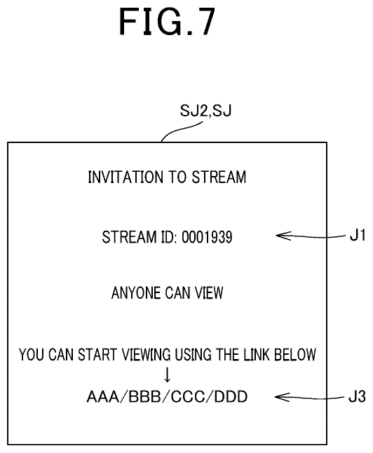

FIG. 7 is a diagram showing an example of the second invite information SJ2.

The second invite information SJ2 is the invite information SJ transmitted without the streamer S designating the viewer U. In other words, the second invite information SJ2 is the invite information SJ transmitted to an unspecified viewer terminal 200B. The second invite information SJ2 does not include the viewer information J2 unlike the first invite information SJ1. On the other hand, the second invite information SJ2 includes the stream ID J1 and the access information J3.

When only the first invite information SJ1 is transmitted, the transmission unit 352 generates the first invite information SJ1 and transmits the generated first invite information SJ1 to the streaming server 100 via the external communication I/F 31. Note that a case where the streamer S desires the viewer U designated by the streamer S to view the image is given as an example of a case where only the first invite information SJ1 is transmitted.

When only the second invite information SJ2 is transmitted, the transmission unit 352 generates the second invite information SJ2 and transmits the generated second invite information SJ2 to the streaming server 100 via the external communication I/F 31. Note that a case where the streamer S desires the viewer U not designated by the streamer S to view the image is given as an example of a case where only the second invite information SJ2 is transmitted.

When the first invite information SJ1 and the second invite information SJ2 are transmitted, the transmission unit 352 generates the first invite information SJ1 and the second invite information SJ2 and transmits the two generated pieces of invite information SJ to the streaming server 100 via the external communication I/F 31. Note that a case where the streamer S desires the viewer U designated by the streamer S to view the image and the viewer U not designated by the streamer S to view the image is given as an example of a case where the first invite information SJ1 and the second invite information SJ2 are transmitted.

### 2-3. Notification Unit

The notification unit 353 notifies, via at least any of the touch panel 34 or the speaker 36, that the invite information SJ has been transferred and that viewing of the image based on the invite information SJ has started.

### 2-4. Speech Output Unit

The speech output unit 354 receives speech data of the viewer U from the streaming server 100 via the external communication I/F 31. The speech output unit 354 then outputs speech indicated by the received speech data of the viewer U via the speaker 36.

### 3. Configuration of Streaming Server

Next, the configuration of the streaming server 100 will be described with reference to FIG. 4.

The streaming server 100 includes a network communication I/F 110 and a second control section 130.

For example, the network communication I/F 110 includes a communication card such as a network interface card (NIC), and performs mutual data communication via the communication network 5 with the vehicle 3, the viewer terminal 200B, and the like.

The second control section 130 is a computer apparatus including a second memory 140 and a second processor 150.

The second memory 140 includes, for example, a volatile semiconductor memory and a non-volatile semiconductor memory. The second memory 140 may include only a non-volatile semiconductor memory. The second memory 140 may include an auxiliary storage apparatus such as a hard disk drive (HDD) or an SSD.

The second memory 140 stores a control program 141 executed by the second processor 150, a user information database 143, and a stream management database 145. Hereinafter, database will be abbreviated as DB.

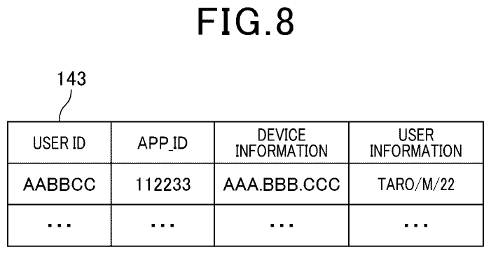

FIG. 8 is a diagram showing a configuration of the user information DB 143.

One record in the user information DB 143 includes a user ID, APP_ID, device information, and user information. APP is an abbreviation of application program.

APP_ID is identification information for identifying an application program downloaded on the streamer terminal 200A or the viewer terminal 200B.

The streamer S and the viewer U download the APP from a predetermined website and respectively install the APP on the streamer terminal 200A and the viewer terminal 200B.

The device information is information related to the viewer terminal 200B. The device information is, for example, information indicating whether the viewer terminal 200B is a smartphone, a PC, a head-mounted display apparatus, or a camera. For example, a model number is used for the device information. The device information includes communication information for communicating with the viewer terminal 200B. Note that an example of this communication information includes address information.

The user information is personal information of the streamer S and the viewer U being the user. The user information includes, for example, information such as name, address, sex, and age.

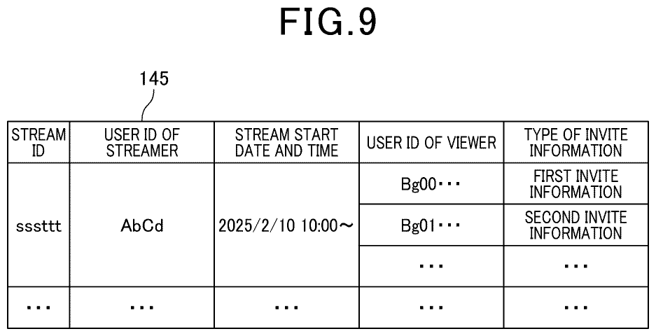

FIG. 9 is a diagram showing a configuration of the stream management DB 145.

One record in the stream management DB 145 includes the stream ID J1, a user ID of the streamer S, and a stream start date and time. In addition, one record in the stream management DB 145 includes a pair of the user ID of the viewer U and a type of the invite information SJ per viewer U that views the image. The type of the invite information SJ indicates based on which piece of invite information SJ that the viewer U has started viewing, and indicates the first invite information SJ1 or the second invite information SJ2.

Returning to FIG. 4, the configuration of the streaming server 100 will be described further.

The second processor 150 is, for example, an arithmetic processing apparatus such as a CPU or an MPU. The second processor 150 may be implemented as a single processor or as a plurality of processors. The second processor 150 may be implemented as an SoC integrated with part or all of the second memory 140, or with another circuit.

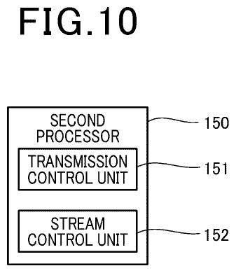

FIG. 10 is a diagram showing functional units of the second processor 150.

The second processor 150 functions as a transmission control unit 151 and a stream control unit 152 by loading and executing the control program 141 stored in the second memory 140.

The stream control unit 152 is an example of an “interaction control unit.”

### 3-1. Transmission Control Unit

The transmission control unit 151 receives the invite information SJ via the network communication I/F 110 and transmits the received invite information SJ to the viewer terminal 200B.

To describe in detail, when receiving the first invite information SJ1 via the network communication I/F 110, the transmission control unit 151 transmits the received first invite information SJ1 to the viewer terminal 200B based on the viewer information J2 included in the first invite information SJ1. To be specific, the transmission control unit 151 identifies a record of the user ID of the viewer U included in the viewer information J2 from the user information DB 143. Subsequently, the transmission control unit 151 acquires communication information from device information of the identified record and transmits the received first invite information SJ1 based on the acquired communication information to the viewer terminal 200B.

With this, the transmission control unit 151 can transmit the first invite information SJ1 to the viewer terminal 200B of the viewer U designated by the streamer S as a target.

When receiving the second invite information SJ2 via the network communication I/F 110, the transmission control unit 151 transmits the received second invite information SJ2 to the viewer terminal 200B. To be specific, the transmission control unit 151 acquires a plurality of pieces of communication information of the viewer terminal 200B from the user information DB 143, and transmits the second invite information SJ2 to a plurality of viewer terminals 200B based on the acquired communication information. Note that the second invite information SJ2 is neither information that imposes a restriction on the number of viewers U, nor information that is transmitted to the viewer U designated by the streamer S. Therefore, the transmission control unit 151 may acquire all pieces of communication information from the user information DB 143, or may acquire the communication information of the viewer U that satisfies a predetermined condition. However, when receiving the first invite information SJ1 and the second invite information SJ2, the transmission control unit 151 preferably transmits the second invite information SJ2 to a viewer terminal 200B other than the viewer terminal 200B to which the first invite information SJ1 is transmitted.

### 3-2. Stream Control Unit

The stream control unit 152 receives content data from the vehicle 3 via the network communication I/F 110. Upon receiving the content data, the stream control unit 152 identifies the record including the stream ID J1 received together with the content data from the stream management DB 145 and acquires the user ID of the viewer U from the identified record. Subsequently, the stream control unit 152 acquires the device information per acquired user ID of the viewer U. The stream control unit 152 then transmits the received content data, based on the communication information included in the acquired device information.

During streaming of the content, the stream control unit 152 receives speech data of the viewer U from the viewer terminal 200B via the network communication I/F 110. The stream ID J1 of the stream being viewed by the viewer U and the user ID of the viewer U is added to the speech data of the viewer U. The stream control unit 152 identifies the record of the stream ID J1 added to the speech data from the stream management DB 145, and acquires all types of the invite information SJ associated with the identified stream ID J1.

When all acquired types of the invite information SJ indicate the first invite information SJ1, the stream control unit 152 transmits the received speech data of the viewer U to the vehicle 3.

With this, when all viewers U are the viewer U designated by the streamer S when transmitting the invite information SJ, the streamer S can interact with the viewer U.

When all of the acquired types of the invite information SJ indicate the second invite information SJ2, the stream control unit 152 transmits the received speech data of the viewer U to the vehicle 3.

With this, when all viewers U are the viewer U not designated by the streamer S when transmitting the invite information SJ, the streamer S can interact with the viewer U.

When both of the first invite information SJ1 and the second invite information SJ2 are present in the acquired types of the invite information SJ, the stream control unit 152 identifies, from the stream management DB 145, the types of the invite information SJ associated with the user ID of the viewer U added to the received speech data of the viewer U. Subsequently, when the identified type of the invite information SJ indicates the first invite information SJ1, the stream control unit 152 transmits the received speech data of the viewer U to the vehicle 3. On the other hand, when the identified type of the invite information SJ indicates the second invite information SJ2, the stream control unit 152 does not transmit the received speech data of the viewer U to the vehicle 3.

With this, when the viewer U designated by the streamer S when transmitting the invite information SJ and the viewer U not designated by the streamer S when transmitting the invite information SJ are present among the viewers U, the streamer S can interact with only the viewer U designated when transmitting the invite information SJ.

### 4. Configuration of Viewer Terminal

FIG. 11 is a block diagram showing a configuration of the viewer terminal 200B.

The viewer terminal 200B includes a wireless communication I/F 210, a second short-range wireless communication I/F 220, the HMI(Human machine Interface) 230, the display 240, the microphone 250, the speaker 260, and a third control section 270.

The wireless communication I/F 210 is a communication module that performs wireless communication in accordance with a mobile communication standard such as LTE, 4G, 5G, or Wi-Fi. The wireless communication I/F 210 is connected to the communication network 5 via an antenna (not shown) and performs mutual data transmission/reception with the streaming server 100.

For example, the second short-range wireless communication I/F 220 (transmitter/receiver, circuit) is a communication module that performs communication in accordance with an NFC standard such as Bluetooth or Wi-Fi.

The HMI 230 is a touch panel, a speech response apparatus, a switch, or the like. The HMI 230 accepts various instructions from the viewer U on the viewer terminal 200B.

The microphone 250 is a speech input apparatus for inputting speech of the streamer S, the viewer U, and the like. The speaker 260 is a speech output apparatus for outputting speech of the streamer S, the viewer U, and the like.

The display 240 includes a display panel such as a liquid-crystal panel or an organic EL panel. The display 240 functions as a display part for displaying an image.

The third control section 270 is a computer apparatus including a third memory 280 and a third processor 290.

The third memory 280 includes a non-volatile semiconductor memory. The third memory 280 may include an auxiliary storage apparatus such as an SD card. The third memory 280 stores control programs such as an operating system (OS) 281 and an APP 283, and the viewer information J2. The APP 283 is an application program that performs mutual data communication with the streaming server 100, displays an image included in content streamed by the streaming server 100 on the display 240, and outputs speech included in the content to the speaker 260.

The third processor 290 is, for example, an arithmetic processing apparatus such as a CPU or an MPU. The third processor 290 may be implemented as a single processor or as a plurality of processors.

The third control section 270 executes various operations by the third processor 290 loading and executing the APP 283. An operation of the third control section 270 will be described in detail below.

### 5. Operation

Next, an operation of each unit of the streaming system 1 according to the present embodiment will be described.

### 5-1. Operation Related to Transmission of First Invite Information and Transfer of First Invite Information

First, an operation of each unit of the streaming system 1 related to transmission and transfer of the first invite information SJ1 will be described.

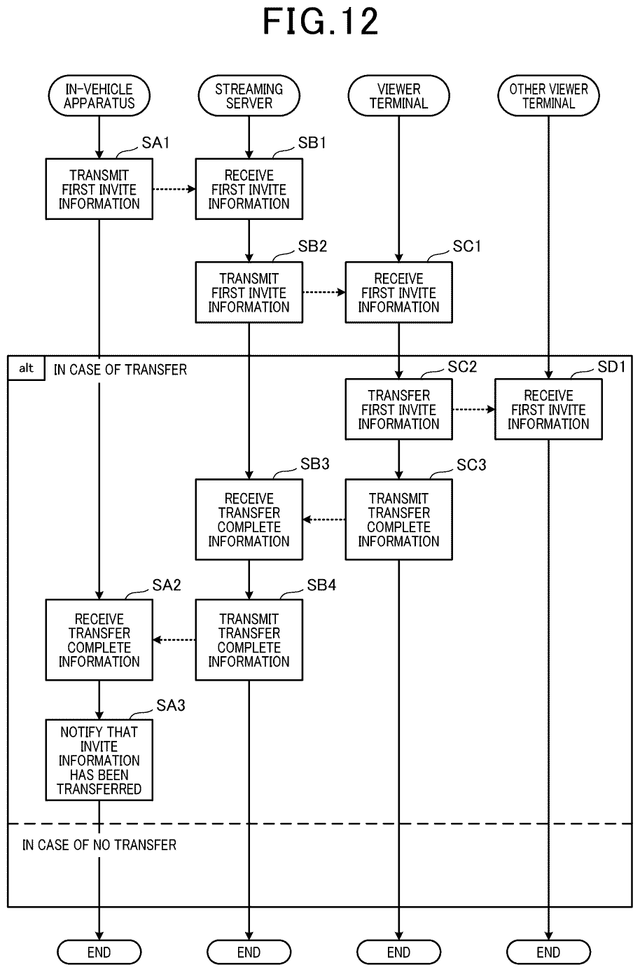

FIG. 12 is a sequence diagram showing the operation of the in-vehicle apparatus 30, the streaming server 100, the viewer terminal 200B, and another viewer terminal 200B. The other viewer terminal 200B refers to a viewer terminal 200B that does not receive the first invite information SJ1 from the vehicle 3.

When the streamer S performs a transmission instruction for the first invite information SJ1 on the touch panel 34, the transmission unit 352 transmits the first invite information SJ1 to the streaming server 100 (step SA1).

Subsequently, upon receiving the first invite information SJ1 (step SB1), the transmission control unit 151 transmits the first invite information SJ1 to the viewer terminal 200B based on the viewer information J2 included in the received first invite information SJ1 (step SB2).

The third control section 270 of the viewer terminal 200B receives the first invite information SJ1 (step SC1).

Step SC1 is an example of a “reception step.”

Subsequently, when transferring the first invite information SJ1 to another viewer terminal 200B, the third control section 270 of the viewer terminal 200B transfers the first invite information SJ1 received in step SC1 to the other viewer terminal 200B (step SC2). Note that step SC2 is performed when a transfer instruction is performed on the HMI 230. The third control section 270 of the other viewer terminal 200B receives the first invite information SJ1 transferred from the viewer terminal 200B (step SD1).

Subsequently, the third control section 270 of the viewer terminal 200B transmits, to the streaming server 100, transfer complete information indicating that the first invite information SJ1 has been transferred (step SC3).

Upon receiving the transfer complete information (step SB3), the transmission control unit 151 transmits the received transfer complete information to the vehicle 3 (step SB4).

Upon receiving the transfer complete information from the streaming server 100 via the external communication I/F 31 (step SA2), the notification unit 353 notifies that the first invite information SJ1 has been transferred (step SA3).

Step SA3 is an example of a “notification step.”

Step SA3 will be described in detail below.

For example, the notification unit 353 notifies that “the invite information has been transferred” via the touch panel 34, the speaker 36, or the like.

For example, assume that the streamer S has transmitted the first invite information SJ1 to a viewer terminal 200B of a care recipient being a relative. Furthermore, assume that the viewer terminal 200B of the care recipient has transferred the first invite information SJ1 to a viewer terminal 200B of a caregiver. In this case, the streamer S is notified that the first invite information SJ1 has been transferred. With this, the streamer S is capable of knowing that the first invite information SJ1 has been transferred to the caregiver and whether the caregiver may be present among the viewers U.

### 5-2. Transmission of Second Invite Information

Next, an operation related to transmission of the second invite information SJ2 will be described.

Illustration will be omitted in the description of the operation related to the transmission of the second invite information SJ2.

When the streamer S performs a transmission instruction for the second invite information SJ2 on the touch panel 34, the transmission unit 352 transmits the second invite information SJ2 to the streaming server 100.

Subsequently, upon receiving the second invite information SJ2, the transmission control unit 151 transmits the received second invite information SJ2 to the viewer terminal 200B with reference to the user information DB 143.

### 5-3. Start of Viewing Based on First Invite Information

Next, an operation of each unit of the streaming system 1 will be described when viewing of the image is started based on the first invite information SJ1.

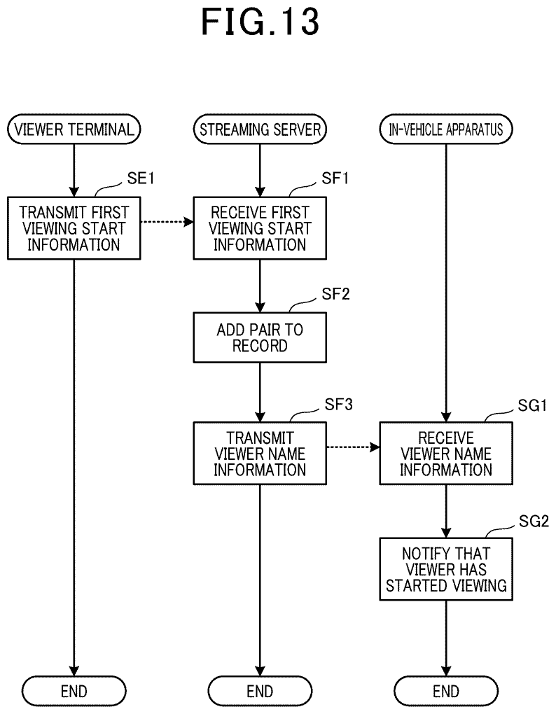

FIG. 13 is a sequence diagram showing the operation of the viewer terminal 200B, the streaming server 100, and the in-vehicle apparatus 30.

The operation of the viewer terminal 200B shown in FIG. 13 is the operation of the viewer terminal 200B having received the first invite information SJ1, and also includes the operation of another viewer terminal 200B having received the transferred first invite information SJ1.

When the viewer U starts viewing the image using the access information J3 of the first invite information SJ1, the third control section 270 transmits first viewing start information to the streaming server 100 (step SE1).

The first viewing start information is information indicating that viewing of the image has started based on the first invite information SJ1, and includes the stream ID J1 included in the first invite information SJ1. The first viewing start information includes the viewer information J2 stored in the third memory 280.

Upon receiving the first viewing start information from the viewer terminal 200B (step SF1), the stream control unit 152 identifies the record of the stream ID J1 included in the first viewing start information from the stream management DB 145, and adds the pair of the user ID of the viewer U and the type of the invite information SJ indicating the first invite information SJ1 to the identified record (step SF2).

Step SF2 will be described in detail below.

The stream control unit 152 adds the pair of the user ID included in the viewer information J2 and the type of the invite information SJ indicating the first invite information SJ1, based on the viewer information J2 of the first viewing start information received in step SF1.

Subsequently, the stream control unit 152 transmits received viewer name information to the in-vehicle apparatus 30 (step SF3). The viewer name information is information indicating the name of the viewer U, and includes the name of the viewer U included in the viewer information J2 of the first viewing start information.

Upon receiving the viewer name information from the streaming server 100 (step SG1), the notification unit 353 notifies that the viewer U has started viewing (step SG2).

Step SG2 will be described in detail below.

The notification unit 353 notifies that viewing has started along with the name of the viewer U included in the viewer name information. For example, the notification unit 353 notifies that “Taro has started viewing” via the touch panel 34, the speaker 36, or the like.

For example, assume that the streamer S has transmitted the first invite information SJ1 to the viewer terminal 200B of the care recipient being a relative. Furthermore, assume that the viewer terminal 200B of the care recipient has transferred the first invite information SJ1 to the viewer terminal 200B of the caregiver. In this case, upon starting viewing of the image on the viewer terminal 200B of the care recipient, the streamer S is notified of a name of the caregiver. With this, the streamer S is capable of recognizing that the care recipient being a relative is viewing the image together with the caregiver or with assistance from the caregiver.

### 5-4. Start of Viewing Based on Second Invite Information

Next, an operation of each unit of the streaming system 1 will be described when viewing of the image is started based on the second invite information SJ2.

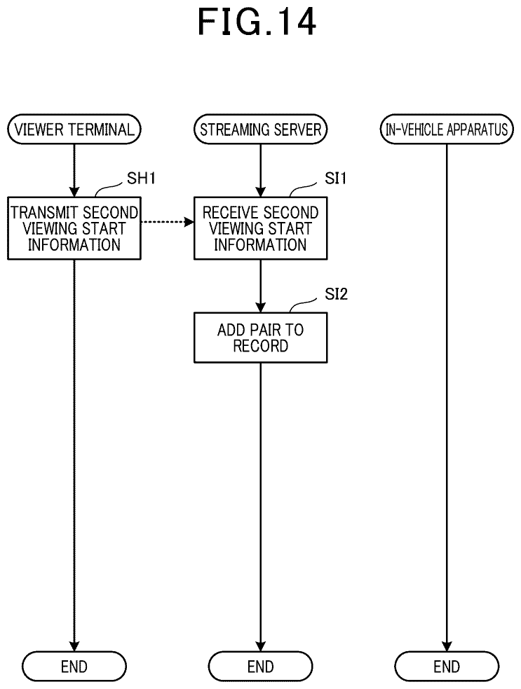

FIG. 14 is a sequence diagram showing the operation of the viewer terminal 200B and the streaming server 100. Note that FIG. 14 also shows a flow of the operation of the in-vehicle apparatus 30 for comparison with FIG. 13.

Upon starting viewing of the image using the access information J3 included in the second invite information SJ2, the third control section 270 transmits second viewing start information to the streaming server 100 (step SH1). The second viewing start information is information indicating that viewing of the image has started based on the second invite information SJ2, and includes the stream ID J1. The second viewing start information includes the viewer information J2 stored in the third memory 280.

Upon receiving the second viewing start information from the viewer terminal 200B (step SI1), the stream control unit 152 identifies the record of the stream ID J1 included in the second viewing start information from the stream management DB 145, and adds the pair of the user ID of the viewer U and the type of the invite information SJ indicating the second invite information SJ2 to the identified record (step SI2).

Step SI2 will be described in detail below.

The stream control unit 152 adds the pair of the user ID included in the viewer information J2 and the type of the invite information SJ indicating the second invite information SJ2, based on the viewer information J2 of the second viewing start information received in step SI1.

As is clear from comparison with FIG. 13, the streaming server 100 ends the present processing without transmitting the second viewing start information to the in-vehicle apparatus 30. Thus, in the streaming system 1, the in-vehicle apparatus 30 does not notify the streamer S even if the viewing of the image starts based on the second invite information SJ2.

### 5-5. Operation Related to Starting Streaming of Content and Ending Streaming of Content

First, an operation of each unit of the streaming system 1 related to starting streaming of content and ending streaming of content will be described.

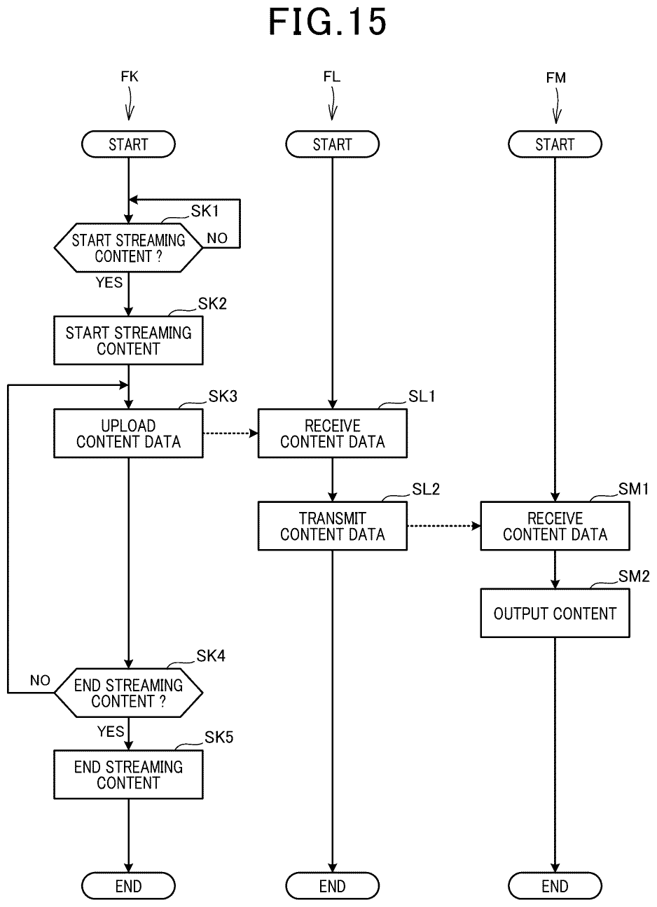

FIG. 15 shows flowcharts showing the operation of the in-vehicle apparatus 30, the streaming server 100, and the viewer terminal 200B. In FIG. 15, a flowchart FK indicates the operation of the in-vehicle apparatus 30, a flowchart FL indicates the operation of the streaming server 100, and a flowchart FM indicates the operation of the viewer terminal 200B.

Note that In FIG. 15, viewing is started in accordance with FIGS. 13 and 14 before the viewer terminal 200B performs the processing of step SM1.

As shown in the flowchart FK, the streaming unit 351 determines whether to start streaming the content (step SK1).

For example, when the touch panel 34 receives a streaming start instruction, the streaming unit 351 makes a positive determination in step SK1.

For example, when the in-vehicle apparatus 30 receives streaming start information from the streamer terminal 200A, the streaming unit 351 makes the positive determination in step SK1. Note that the streaming start information is information indicating the start of streaming.

When determining to start streaming the content (YES in step SK1), the streaming unit 351 starts streaming the content (step SK2). Upon starting streaming of the content, the streaming unit 351 uploads the content data at predetermined intervals to the streaming server 100 (step SK3).

As shown in the flowchart FL, the stream control unit 152 receives the content data from the in-vehicle apparatus 30 (step SL1).

Subsequently, the stream control unit 152 transmits the received content data to the viewer terminal 200B (step SL2).

As shown in the flowchart FM, the third control section 270 of the viewer terminal 200B receives the content data from the streaming server 100 (step SM1).

Subsequently, the third control section 270 displays the image included in the content indicated by the received content data on the display 240 and outputs the speech included in the content indicated by the received content data via the speaker 260 (step SM2).

Returning to the description of the flowchart FK, the streaming unit 351 determines whether to end streaming the content (step SK4).

For example, when the touch panel 34 receives a streaming end instruction, the streaming unit 351 makes a positive determination in step SK4.

For example, when the in-vehicle apparatus 30 receives streaming end information from the streamer terminal 200A, the streaming unit 351 makes the positive determination in step SK4. Note that the streaming end information is information indicating the end of streaming.

When determining not to end streaming the content (NO in step SK4), the streaming unit 351 returns the processing to step SK3 and performs the processing from step SK3 onward once more. Note that the streaming unit 351 continues streaming the content until the positive determination is made in step SK4.

On the other hand, when determining to end streaming the content (YES in step SK4), the streaming unit 351 ends streaming the content (step SK5).

### 6. Other Embodiments

The above-described embodiment indicates merely one aspect and can be freely modified and applied.

In the above-described embodiment, the transferable count of the first invite information SJ1 is one time. In another embodiment, if the transferable count of the first invite information SJ1 is restricted, the transferable count of the first invite information SJ1 is not limited to one time. For example, the transferable count of the first invite information SJ1 may be two or three times.

In the above-described embodiment, when all viewers U have started viewing based on the second invite information SJ2, the streamer S and the viewer U can interact. In another embodiment, the streamer S and the viewer U need not be able to interact in this case.

In the above-described embodiment, when both of the viewer U having started viewing based on the first invite information SJ1 and the viewer U having started viewing based on the second invite information SJ2 are present among the viewers U, the streamer S and the viewer U having started viewing based on the first invite information SJ1 can interact. In another embodiment, when the streamer S and the viewer U can interact via means other than speech (for example, chat), interaction via the means other than speech may be possible between the streamer S and all viewers U.

In the above-described embodiment, the streaming server 100 performs control that enables interaction between the streamer S and the viewer U. In another embodiment, the control may be performed by the vehicle 3. In this case, the in-vehicle apparatus 30 distinguishes whether the speech data of the viewer U transmitted from the streaming server 100 is speech data of the viewer U having started viewing based on the first invite information SJ1 or speech data of the viewer U having started viewing based on the second invite information SJ2. The in-vehicle apparatus 30 performs similar control to the stream control unit 152 of the above-described embodiment. Note that in the case of this other embodiment, the speech output unit 354 of the first processor 350 functions as the “interaction control unit.”

In the above-described embodiment, the streaming unit 351 of the in-vehicle apparatus 30 uploads the content data to the streaming server 100 via the external communication I/F 31. In another embodiment, the streamer terminal 200A may upload the content data to the streaming server 100. More specifically, in this case, the streamer terminal 200A uploads, to the streaming server 100, the content data including the image captured by the camera included in the streamer terminal 200A and the speech input via the microphone included in the streamer terminal 200A.

The configuration of each unit of the streaming system 1 shown in FIGS. 4 and 11 is merely an example, and a specific implementation form thereof is not particularly limited. In other words, it is not necessarily required that separate pieces of hardware be provided for the respective components, and the functions of the respective components may be realized by a single processor executing a program. Some functions realized by software in the above-described embodiment may be realized by hardware, or alternatively, some functions realized by hardware may be realized by software.

The step units of the operations shown in FIGS. 12, 13, 14, and 15 are divided in accordance with their main processing content, and the present invention is not limited by the manner in which the processing units are divided or by the names assigned to those processing units. One step unit may be divided into a greater number of step units in accordance with the processing content. One step unit may be divided so as to include a greater amount of processing. The order of these steps may be rearranged as appropriate so as not to impede the gist of the present invention.

### 7. Configurations Supported by Above Embodiment

The above embodiment supports the following configurations.

### Configuration 1

A streaming system including: a vehicle in which a capturing apparatus is provided and configured to stream an image obtained through capturing by the capturing apparatus; and a terminal apparatus provided in a location other than the vehicle and configured to receive, from the vehicle, invite information for inviting viewing of the streamed image, wherein when the invite information is transferred from the terminal apparatus to another terminal apparatus, the vehicle notifies an occupant of the vehicle that the invite information has been transferred.

According to the streaming system of configuration 1, the occupant of the vehicle is capable of knowing whether the invite information has been transferred. Thus, the occupant of the vehicle is capable of knowing that someone who has not been invited via the invite information can become a viewer.

### Configuration 2

The streaming system according to configuration 1, wherein when a user of the other terminal apparatus starts viewing the image based on the transferred invite information, the vehicle notifies the occupant of the vehicle that the user of the other terminal apparatus has started viewing the image.

According to the streaming system of configuration 2, the occupant of the vehicle is capable of knowing that viewing of the image has started based on the transferred invite information. Thus, the occupant of the vehicle is capable of knowing whether a viewer is present who has not been invited via the invite information among viewers viewing the image.

### Configuration 3

The streaming system according to configuration 1 or 2, wherein the vehicle transmits at least any of first invite information or second invite information, and notifies that the invite information has been transferred when the first invite information is transferred from the terminal apparatus to the other terminal apparatus, the first invite information includes viewer information of a viewer designated by the occupant of the vehicle, and is the invite information transmitted to the terminal apparatus of the viewer designated by the occupant of the vehicle, and the second invite information does not include the viewer information, and is the invite information transmitted to a plurality of the terminal apparatuses without the occupant of the vehicle designating a viewer.

When the occupant of the vehicle designates a viewer, the occupant of the vehicle may want to know whether the invite information has been transferred. On the other hand, when the occupant of the vehicle has not designated a viewer, the necessity of knowing whether the invite information has been transferred is low. This is because the necessity of knowing who is viewing is low when the occupant of the vehicle has not designated a viewer. Therefore, according to the streaming system of configuration 3, it is notified that the invite information has been transferred to the terminal apparatus of the viewer designated by the occupant of the vehicle in a configuration in which the first invite information and the second invite information can be transmitted. Thus, it is possible to reduce unnecessary notifications to the occupant of the vehicle.

### Configuration 4

The streaming system according to configuration 3, wherein a transferable count of the first invite information is restricted.

According to the streaming system of configuration 4, it is possible to reduce spreading viewer information by transferring the invite information, while avoiding a situation in which the invite information cannot be transferred.

### Configuration 5

The streaming system according to configuration 4, wherein the transferable count of the first invite information is one time.

According to the streaming system of configuration 5, it is possible to further reduce spreading the viewer information by transferring the invite information, while avoiding a situation in which the invite information cannot be transferred.

### Configuration 6

The streaming system according to any one of configurations 3 to 5, wherein when viewing of the image starts based on the second invite information, the vehicle does not notify the occupant of the vehicle that viewing of the image has started.

According to the streaming system of configuration 6, it is possible to prevent notifying the occupant each time viewing of the image starts based on the second invite information. Thus, it is possible to prevent bothering the occupant of the vehicle by notifying the occupant of the vehicle a plurality of times, regardless of whether the occupant of the vehicle has not designated a viewer, in other words, regardless of whether the necessity of knowing who is viewing is low.

### Configuration 7

The streaming system according to any one of configurations 3 to 6, including an interaction control unit configured to enable interaction between the viewer having started viewing the image based on the first invite information and the occupant of the vehicle, when viewing of the image is started based on the first invite information and when viewing of the image is started based on the second invite information.

According to the streaming system of configuration 7, when both of the viewer designated by the occupant of the vehicle and the viewer not designated by the occupant of the vehicle are present among the viewers, the viewer designated by the occupant of the vehicle and the occupant of the vehicle can interact. Thus, the occupant of the vehicle is not obstructed by the viewer not designated by the occupant of the vehicle to interact with the viewer designated by the occupant of the vehicle. Therefore, it is possible to realize streaming the image in a manner that is convenient for the occupant of the vehicle.

### Configuration 8

A non-transitory computer readable storage medium storing a program for causing a processor to function as: a streaming unit configured to stream an image obtained through capturing by a capturing apparatus provided in a vehicle; a transmission unit configured to transmit invite information for inviting viewing of the image to a terminal apparatus provided in a location other than the vehicle; and a notification unit configured to notify an occupant of the vehicle that the invite information has been transferred, when the invite information is transferred from the terminal apparatus to another terminal apparatus.

According to the storage medium of configuration 8, it is possible to achieve the same effects as the streaming system of configuration 1.

### Configuration 9

A streaming method of streaming, by a vehicle in which a capturing apparatus is provided, an image obtained through capturing by the capturing apparatus, the streaming method including: a reception step of receiving, by a terminal apparatus provided in a location other than the vehicle, invite information for inviting viewing of the image from the vehicle; and a notification step of notifying, by the vehicle, an occupant of the vehicle that the invite information has been transferred, when the invite information is transferred from the terminal apparatus to another terminal apparatus.

According to the streaming method of configuration 9, it is possible to achieve the same effects as the streaming system of configuration 1.

### REFERENCE SIGNS LIST

1 streaming system
3 vehicle
5 communication network
10 seat
11 backrest
12 headrest
13 headrest stay
30 in-vehicle apparatus
31 external communication I/F
32 first short-range wireless communication I/F
33 internal communication I/F
34 touch panel
35 speech processing unit
36 speaker
37 internal microphone
40 vehicle ECU
50 attachment
51 first holder
100 streaming server
110 network communication I/F
130 second control section
140 second memory
141 control program
143 user information database
145 stream management database
150 second processor
151 transmission control unit
152 stream control unit
200A streamer terminal (capturing apparatus)
200B viewer terminal (terminal apparatus)
210 wireless communication I/F
220 second short-range wireless communication I/F
230 HMI
240 display
250 microphone
260 speaker
270 third control section
280 third memory
281 OS
283 APP
290 third processor
310 input/output I/F
330 first control section
340 first memory
345 control program (program)
350 first processor (processor)
351 streaming unit
352 transmission unit
353 notification unit
354 speech output unit
J2 viewer information
J3 access information
S streamer (occupant of vehicle)
SA3 step (notification step)
SC1 step (reception step)
SJ invite information
SJ1 first invite information
SJ2 second invite information
U viewer

1. A streaming system comprising:
a vehicle in which a capturing apparatus is provided and configured to stream an image obtained through capturing by the capturing apparatus; and
a terminal apparatus provided in a location other than the vehicle and configured to receive, from the vehicle, invite information for inviting viewing of the streamed image, wherein
when the invite information is transferred from the terminal apparatus to another terminal apparatus, the vehicle notifies an occupant of the vehicle that the invite information has been transferred.

2. The streaming system according to claim 1, wherein
when a user of the other terminal apparatus starts viewing the image based on the transferred invite information, the vehicle notifies the occupant of the vehicle that the user of the other terminal apparatus has started viewing the image.

3. The streaming system according to claim 1, wherein
the vehicle transmits at least any of first invite information or second invite information, and notifies that the invite information has been transferred when the first invite information is transferred from the terminal apparatus to the other terminal apparatus,
the first invite information includes viewer information of a viewer designated by the occupant of the vehicle, and is the invite information transmitted to the terminal apparatus of the viewer designated by the occupant of the vehicle, and
the second invite information does not include the viewer information, and is the invite information transmitted to a plurality of the terminal apparatuses without the occupant of the vehicle designating a viewer.

4. The streaming system according to claim 3, wherein
a transferable count of the first invite information is restricted.

5. The streaming system according to claim 4, wherein
the transferable count of the first invite information is one time.

6. The streaming system according to claim 3, wherein
when viewing of the image starts based on the second invite information, the vehicle does not notify the occupant of the vehicle that viewing of the image has started.

7. The streaming system according to claim 3, comprising an interaction control unit configured to enable interaction between the viewer having started viewing the image based on the first invite information and the occupant of the vehicle, when viewing of the image is started based on the first invite information and when viewing of the image is started based on the second invite information.

8. A non-transitory computer readable storage medium storing a program for causing a processor to function as:
a streaming unit configured to stream an image obtained through capturing by a capturing apparatus provided in a vehicle;
a transmission unit configured to transmit invite information for inviting viewing of the image to a terminal apparatus provided in a location other than the vehicle; and
a notification unit configured to notify an occupant of the vehicle that the invite information has been transferred, when the invite information is transferred from the terminal apparatus to another terminal apparatus.

9. A streaming method of streaming, by a vehicle in which a capturing apparatus is provided, an image obtained through capturing by the capturing apparatus, the streaming method comprising:
a reception step of receiving, by a terminal apparatus provided in a location other than the vehicle, invite information for inviting viewing of the image from the vehicle; and
a notification step of notifying, by the vehicle, an occupant of the vehicle that the invite information has been transferred, when the invite information is transferred from the terminal apparatus to another terminal apparatus.
